(19) United States
(12) Patent Application Publication
(10) Pub. No.: US 2023/0085543 A1
(43) Pub. Date: Mar. 16, 2023

(54) POWER TOOL AND BLOWER

(71) Applicant: Nanjing Chervon Industry Co., Ltd., Nanjing (CN)

(72) Inventors: Shutao Zheng, Nanjing (CN); Shuang Li, Nanjing (CN); Huaishu Wang, Nanjing (CN); Meixiong Lai, Nanjing (CN); Jiwei Feng, Nanjing (CN)

(21) Appl. No.: 17/889,087

(22) Filed: Aug. 16, 2022

(30) Foreign Application Priority Data
Sep. 14, 2021 (CN) 202111071979.8

(51) Int. Cl. A01G 20/47

(52) U.S. Cl. CPC A01G 20/47

(57) ABSTRACT

A power tool includes a housing, a drive motor, an energy source interface, a first switch, a second switch, and a control unit. The energy source interface is used for access to an energy source to provide a power supply for the drive motor. The first switch is disposed on a power supply circuit of the power supply and is capable of controlling the drive motor to rotate in a full power output mode. The second switch is disposed on a power supply circuit of the power supply and is capable of controlling the drive motor to rotate in a variable power mode. The control unit is capable of controlling the drive motor to rotate in the full power output mode when the first switch is turned on and of controlling the drive motor to rotate in a variable power output mode when the second switch is turned on.

### RELATED APPLICATION INFORMATION

This application claims the benefit under 35 U.S.C. § 119(a) of Chinese Patent Application No. CN 202111071979.8, filed on Sep. 14, 2021, which application is incorporated herein by reference in its entirety.

### BACKGROUND

A blower, as a gardening tool, can be used for cleaning places such as yards and streets. For commonly used blowers, different wind speeds can be selected according to the degrees of coverage of debris such as rubbish, branches, or leaves in places. The wind speed is typically increased from a lowest gear sequentially during the selection of the wind speed. However, in the scenario where the blower needs to continuously operate at a relatively high wind speed due to a relatively large amount of debris, the process of gradually increasing the wind speed through a speed regulation switch suggests that the blower cannot respond promptly. In addition, the process of gradually increasing the wind speed will also reduce the efficiency of a maximum wind speed to a certain extent.

### SUMMARY

A power tool includes a housing, a drive motor, an energy source interface, a first switch, a second switch, and a control unit. The drive motor is disposed within the housing to provide a driving force for the power tool. The energy source interface is used for access to an energy source so as to provide a power supply for the drive motor. The first switch is disposed on a power supply circuit of the power supply and is capable of controlling the drive motor to rotate in a full power output mode. The second switch is disposed on a power supply circuit of the power supply and is capable of controlling the drive motor to rotate in a variable power mode. The control unit is electrically connected to at least the first switch and/or the second switch. The control unit is configured to detect a state of the first switch and a state of the second switch, control the drive motor to rotate in the full power output mode in response to the first switch being turned on, and control the drive motor to rotate in a variable power output mode in response to the second switch being turned on.

In an example, maximum output power of the drive motor operating in the variable power output mode is less than output power of the drive motor operating in the full power output mode.

In an example, the full power output mode corresponds to a maximum rotational speed of the drive motor; and the variable power output mode corresponds to multiple speed regulation gears of the drive motor.

In an example, the control unit is configured to control the drive motor to stop rotating in response to the first switch being turned off and control the drive motor to stop rotating in response to the second switch being turned off.

In an example, the control unit is configured to control the drive motor to rotate in the full power output mode in response to the first switch and the second switch being turned on.

In an example, the power tool further includes a storage unit for storing operation data output by the control unit, where the control unit is configured to: in the process where the drive motor operates in the variable power output mode, in response to the first switch being turned on, acquire a first rotational speed of the drive motor when the first switch is turned on, store the first rotational speed in the storage unit, and control the drive motor to enter the full power output mode.

In an example, the control unit is configured to control the drive motor to resume rotating at the first rotational speed in response to the first switch being turned off.

In an example, the control unit is configured to: in the process where the drive motor operates in the full power output mode, in response to the second switch being turned on, keep the drive motor rotating in the full power output mode.

In an example, the control unit is configured to: in the process where the drive motor operates in the full power output mode, in response to the second switch being turned on, detect a corresponding current speed regulation gear when the second switch is turned on, and in response to the first switch being turned off, control the drive motor to switch to a rotational speed of the drive motor corresponding to the current speed regulation gear.

In an example, the control unit detects an on state of the first switch and/or an on state of the second switch in real time or periodically.

In an example, the first switch and the second switch are connected in parallel between the energy source and the control unit.

In an example, any one of the second switch and the first switch is capable of individually controlling the drive motor to start and stop.

In an example, the first switch is a signal switch.

In an example, in the process where the drive motor rotates in the variable power output mode, a rotational speed of the drive motor is capable of being gradually increased from low to high.

A power tool includes a housing, a drive motor, an energy source interface, a first switch, a second switch, and a control unit. The drive motor is disposed within the housing to provide a driving force for the blower. The energy source interface is used for access to an energy source so as to provide a power supply for the drive motor. The first switch is disposed on a power supply circuit of the power supply. The second switch is disposed on a power supply circuit of the power supply. The control unit is electrically connected to at least the first switch and/or the second switch. The control unit is configured to detect a state of the first switch and a state of the second switch, control the drive motor to rotate in a first operation mode in response to the first switch being turned on, and control the drive motor to rotate in a second operation mode in response to the second switch being turned on.

In an example, output power of the drive motor operating in the first operation mode is different from output power of the drive motor operating in the second operation mode.

A blower includes a housing, a drive motor, a power interface, a first switch, and a second switch. The drive motor is disposed within the housing to provide a driving force for the blower. The power interface is used for access to a power supply so as to provide the power supply for the drive motor. The first switch is disposed on a power supply circuit of the power supply and is capable of controlling the drive motor to rotate in a maximum rotational speed output mode. The second switch is disposed on a power supply circuit of the power supply and is capable of controlling the drive motor to rotate in a variable rotational speed output mode. A control unit is configured to detect a state of the first switch and a state of the second switch, control the drive motor to rotate in the maximum rotational speed output mode in response to the first switch being turned on, and control the drive motor to rotate in the variable rotational speed output mode in response to the second switch being turned on.

In an example, output power of the drive motor operating in a first operation mode is greater than maximum output power of the drive motor operating in a second operation mode.

In an example, the blower is capable of outputting a maximum wind force in a first operation mode.

In an example, the drive motor has multiple speed regulation gears in a second operation mode.

### BRIEF DESCRIPTION OF DRAWINGS

FIG. 1 is a structural view of a blower in an example of the present application;

FIG. 2 is a switch control circuit diagram of the blower in FIG. 1;

FIG. 3 is a switch control circuit diagram of the blower in FIG. 1;

FIG. 4 is a switch control flowchart of the blower in FIG. 1; and

FIG. 5 is a switch control flowchart of the blower in FIG. 1.

### DETAILED DESCRIPTION

The present application is described below in detail in conjunction with drawings and examples.

It is to be understood that the examples described herein are intended to illustrate the present application and not to limit the present application. It is to be noted that for ease of description, only part, not all, of structures related to the present application are illustrated in the drawings.

It is to be understood that a blower 100 in the present application may be a handheld blower or a backpack blower.

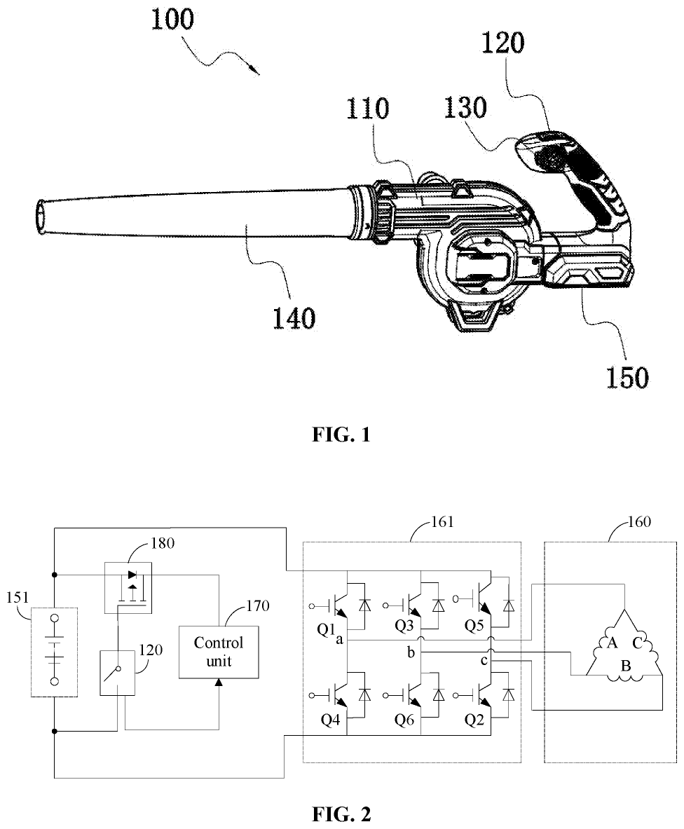

Referring to FIGS. 1 to 3, the blower 100 includes a housing 110, and a first switch 120 and a second switch 130 are disposed on a handle of the housing 110. A blower tube 140 is disposed at one end of the housing 110, and an energy source interface 150 is disposed at the other end of the housing 110. A drive motor 160 is disposed within the housing 110, and the drive motor 160 is capable of providing power for the blower tube 140. A main control board including a control unit 170 is further disposed in the housing 110. The control unit 170 is connected to at least the first switch 120 or the second switch 130 and can output a control signal for controlling the drive motor 160 to rotate, stop, or change a rotational speed.

The preceding energy source interface 150 is used for access to an energy source 151. The interface may be a slidable or pluggable battery pack interface or may be a universal serial bus (USB) interface for connecting other portable power supplies such as a power station.

In an example, as shown in FIG. 2, a driver circuit 161 is further disposed between the drive motor 160 and the control unit 170. The driver circuit 161 may receive the control signal output from the control unit 170 and control the rotational speed or direction of the drive motor 160 by changing a conducting state of the driver circuit 161. Optionally, the driver circuit 161 may be composed of one or more switch elements. In an example, the driver circuit 161 includes multiple switch elements Q1 to Q6. Each gate terminal of the switch elements is electrically connected to the control unit 170 and used for receiving the control signal from the control unit 170. Each drain or source of the switch elements is connected to a stator winding of the drive motor 160. The switch elements Q1 to Q6 receive control signals from the control unit 170 to change their respective conducting states, thereby changing a current applied by a power supply to the stator winding of the motor. In an example, the driver circuit 161 may be a three-phase bridge driver circuit including six controllable semiconductor power devices (for example, field-effect transistors (FETs), bipolar junction transistors (BJTs), insulated-gate bipolar transistors (IGBTs), or the like). It is to be understood that the preceding switch elements may also be any other types of solid-state switches, such as the IGBTs or the BJTs.

To rotate the motor, the driver circuit 161 has multiple driving states. In one driving state, the stator winding of the drive motor 160 generates a magnetic field. The control unit 170 outputs a corresponding pulse-width modulation (PWM) control signal to a switch element in the driver circuit 161 according to a rotor position or a counter-electromotive force of the drive motor 160 such that the driver circuit 161 switches a driving state. Therefore, the stator winding generates a changing magnetic field to drive a rotor to rotate, implementing the rotation or commutation of the drive motor 160. It is to be noted that any other circuit and control manner which can drive the drive motor 160 to rotate or commutate may be used in the present disclosure. A circuit structure of the driver circuit 161 and the control of the driver circuit 161 by the control unit 170 are not limited in the present disclosure.

The first switch 120 is connected between the energy source 151 and the control unit 170 and can determine a powered-up state of the control unit 170. When the first switch 120 is turned on, the control unit 170 is energized and can acquire a signal indicating that the first switch 120 is on, thereby outputting the control signal to the driver circuit 161 to rotate the drive motor 160 in a full power output mode. The so-called full power output mode refers to that the drive motor 160 rotates at maximum power to reach a maximum rotational speed so that the blower tube 140 can output a maximum wind force. The blower 100 can be controlled to operate at a maximum wind speed simply by one switch. Optionally, the first switch 120 may be a signal switch including an off state and an on state. As shown in FIG. 1, the first switch 120 may be directly controlled by a user.

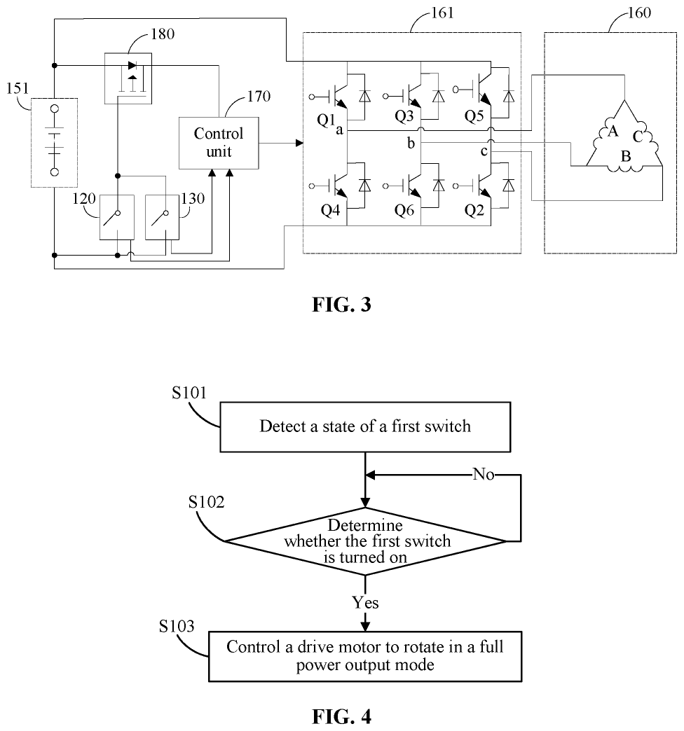

In an example, as shown in FIG. 3, the blower 100 further includes the second switch 130. The second switch 130 is disposed on a power supply circuit of the energy source 151 for supplying power to the control unit 170, and the second switch 130 can determine whether the drive motor 160 rotates in a variable power output mode. That is, turning on or off the second switch 130 is directly related to whether the drive motor 160 rotates in the variable power output mode. The so-called variable power output mode refers to that the drive motor 160 can change the rotational speed of the motor according to a gear selected by the user. Optionally, a toggle switch may be used as the second switch 130, or a slide switch or a rotary switch may be used as the second switch 130 including the off state and the on state. After the second switch 130 is in the on state, the position of a toggle is adjusted so that the voltage across the switch can be adjusted. Thus, the speed regulation function of the switch is implemented.

In an example, when the first switch 120 is turned on, the control unit 170 is energized so that the drive motor 160 can be controlled to rotate in a maximum rotational speed output mode. When the second switch 130 is turned on, the control unit 170 is energized so that the drive motor 160 can be controlled to rotate in a variable rotational speed output mode. The maximum rotational speed output mode may be considered as the maximum rotational speed which can be reached by the drive motor 160 when being powered normally by the power supply. In this example, when the drive motor 160 rotates in the maximum rotational speed output mode or the full power output mode, a constant rotational speed value can be output.

In an example, the drive motor 160 in the blower rotates in the maximum rotational speed output mode at substantially the same rotational speed as it rotates in the full power output mode.

Optionally, the first switch 120 and the second switch 130 are connected in parallel between the energy source 151 and the control unit 170 and can determine the powered-up state of the control unit 170. In an example, a switch element 180, which may be a power switching transistor such as a triode, is connected between the control unit 170 and the energy source 151. One end of the first switch 120 and the second switch 130 is connected to one end of the energy source 151, and the other end of the first switch 120 and the second switch 130 is connected to the gate of the switch element 180. The drain and source of the switch element 180 are connected to the control unit 170 and the other end of the energy source 151, respectively. In a specific implementation, after the first switch 120 and/or the second switch 130 are turned on, the switch element 180 is turned on so that the control unit 170 is energized. After being energized, the control unit 170 can acquire the state of the first switch 120 and the state of the second switch 130 and control the driver circuit 161 to change the driving state according to different states of the two switches so that the drive motor 160 changes a rotational state. That is, when any one of the first switch 120 and the second switch 130 is individually turned on, the control unit 170 can be powered up, that is, control circuits based on the two switches are independent of each other. Therefore, the user can directly control the first switch 120 to be turned on, so as to cause the blower to enter a strongest blowing mode.

In an implementation, when detecting that the first switch 120 is turned on, the control unit 170 controls the drive motor 160 to operate in the full power output mode, that is, the blower 100 can be directly controlled to output the maximum wind force, so as to suit requirements of the user. When detecting that the second switch 130 is turned on, the control unit 170 controls the drive motor 160 to operate in the variable power output mode. In this mode, the user can select different wind speed gears with a knob, the drive motor 160 rotates at different speeds in these gears, and the blower 100 outputs different wind speeds. For example, the second switch 130 is a knob switch. To adapt to the conventional selection of the wind speed gradually increased from low to high, the second switch 130 may be typically rotated by the user to adjust the rotational speed of the drive motor 160 from low to high. That is, in the variable power output mode, the drive motor 160 can also reach a relatively high rotational speed, but the rotational speed is increased in a certain process. In this mode, the blower is not prompt enough to respond to the special requirement of the user for high-power blowing. Correspondingly, when detecting that the first switch 120 is turned off, the control unit 170 may control the drive motor 160 to stop rotating; alternatively, when detecting that the second switch 130 is turned off, the control unit 170 may control the drive motor 160 to stop rotating. That is, any one of the two preceding switches can individually control the drive motor 160 to start and stop. In this example, in the two preceding cases, the first switch 120 and the second switch 130 each independently control the drive motor 160.

To suit the requirement that the drive motor 160 of the blower 100 flexibly switches between two operation modes, the first switch 120 and the second switch 130 may also be in the on state at the same time. In an example, the second switch 130 may also be turned on when the first switch 120 is in the on state; and the first switch 120 may also be turned on when the second switch 130 is in the on state. Optionally, a storage unit 190 may be further disposed on the control board of the blower 100. The storage unit 190 is used for storing operation data output by the control unit 170, for example, state data of the first switch 120 and/or state data of the second switch 130, rotational speed data of the drive motor 160, and the like.

In an example, in the process where the second switch 130 is on and the drive motor 160 operates in the variable power output mode, the control unit 170 may acquire the rotational speed of the drive motor 160 in real time or at preset intervals. If the control unit 170 detects, in the process where the drive motor 160 operates in the variable power output mode, that the first switch 120 is turned on, the control unit 170 may acquire a first rotational speed of the drive motor 160 before or when the first switch 120 is turned on and store the rotational speed in the storage unit 190. Further, the control unit 170 may switch the operation mode of the drive motor 160 from the variable power output mode to the full power output mode so that the drive motor 160 quickly operates at the maximum rotational speed. Further, when the first switch 120 is turned off, the control unit 170 controls the drive motor 160 to resume operating at the preceding first rotational speed. That is, when the second switch 130 is in the on state, the first switch 120 may be controlled to be turned on at any time so that the drive motor 160 rotates at the maximum rotational speed, and the first switch 120 may be turned off at any time so that the drive motor 160 resumes operating at the rotational speed before or at the time of switching. That is, the first switch 120 may be turned on to interrupt the variable power output mode of the drive motor 160, and the first switch 120 may be turned off to resume the variable power output mode of the drive motor 160.

In an example, in the case where the first switch 120 is turned on and the drive motor 160 operates in the full power output mode, the control unit 170 still maintains the full power output mode of the drive motor 160 when detecting that the second switch 130 is turned on and does not perform mode switching. Optionally, the control unit 170 may acquire a corresponding current speed regulation gear when the second switch 130 is turned on so that when the second switch 130 is still in the on state after the first switch 120 is turned off, the drive motor 160 is controlled to switch from the maximum rotational speed to the rotational speed of the motor corresponding to the current speed regulation gear. That is, when the first switch 120 is in the on state, turning on the second switch 130 cannot affect the state where the drive motor 160 operates at the maximum rotational speed. However, after the first switch 120 is turned off, the rotational speed of the drive motor 160 may be changed according to the speed regulation gear corresponding to the knob of the second switch 130.

In an example, in the case where the first switch 120 is turned on and the drive motor 160 operates in the full power output mode, when detecting that the second switch 130 is turned on, the control unit 170 may control the drive motor 160 to switch from the full power output mode to the variable power output mode and change the rotational speed of the motor according to the speed regulation gear corresponding to the second switch 130.

In an example, as shown in FIG. 3, the first switch 120 and the second switch 130 are disposed on the blower 100. The control unit 170 may detect a state of the first switch 120 and/or a state of the second switch 130 in real time or periodically, where the state of the switch specifically includes the on state and the off state. If the first switch 120 is turned on, the switch element 180 is turned on, the control unit 170 is powered up, and the control unit 170 can detect the on state of the first switch 120. Further, the control unit 170 can control the drive motor 160 to rotate in a first operation mode. If the second switch 130 is turned on, the switch element 180 is turned on, the control unit 170 is powered up, and the control unit 170 can detect the on state of the second switch 130. Further, the control unit 170 can control the drive motor 160 to rotate in a second operation mode. In an example, output power of the drive motor 160 in the first operation mode is greater than maximum output power of the drive motor 160 in the second operation mode. That is, the first operation mode may be the full power output mode in the preceding example, and the second operation mode may be the variable power output mode in the preceding example. In an example, a constant maximum rotational speed of the drive motor 160 in the first operation mode is greater than a maximum rotational speed of the drive motor 160 in the second operation mode. That is, the first operation mode may be the maximum rotational speed output mode in the preceding example, and the second operation mode may be the variable rotational speed output mode in the preceding example.

Optionally, the first operation mode may be the preceding variable power output mode or the preceding variable rotational speed output mode, and the second operation mode may be the preceding full power output mode or the preceding maximum rotational speed output mode. Then, maximum output power in the first operation mode is less than output power in the second operation mode, or a maximum rotational speed which can be reached in the first operation mode is less than a rotational speed constantly output in the second operation mode.

In this example, as described in the preceding example, both the first switch 120 and the second switch 130 may also independently control the drive motor 160 to start and stop and may also be turned on at the same time. For the control logic of the control unit 170 when the two switches are turned on at the same time, reference may be made to the description in the preceding example.

In this example, the blower can be directly controlled by the switches to operate at the maximum wind speed as soon as the blower is started so that the operation modes of the blower are controlled more flexibly.

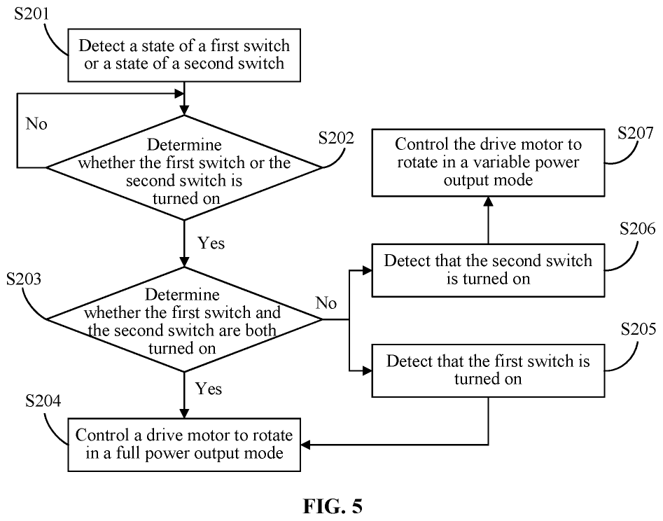

Referring to FIG. 4, a control flow of the blower is shown. The control flow includes the steps described below.

In S101, the state of the first switch is detected.

In a specific implementation, after the first switch is turned on, the control unit is powered up so that the state of the first switch can be detected.

In S102, it is determined whether the first switch is turned on. If so, step S103 is performed. Otherwise, the determination continues.

In S103, the drive motor is controlled to rotate in the full power output mode.

Referring to FIG. 5, another control flow of the blower is shown. The control flow includes the steps described below.

In S201, the state of the first switch or the state of the second switch is detected.

In S202, it is determined whether the first switch or the second switch is turned on. If not, the detection continues. If so, step S203 is performed.

In S203, it is determined whether the first switch and the second switch are both turned on. If so, step S204 is performed. Otherwise, step S205 and step S206 are performed.

In S204, the drive motor is controlled to rotate in the full power output mode.

In S205, step S204 is performed when it is detected that the first switch is turned on.

In S206, step S207 is performed when it is detected that the second switch is turned on.

In S207, the drive motor is controlled to rotate in the variable power output mode.

It is to be understood by those skilled in the art that the examples of the present application described in the preceding description and drawings are examples only and not intended to limit the present application. The object of the present application has been achieved completely and effectively. The function and structural principle of the present application have been shown and illustrated in the examples which may be arbitrarily altered or modified without departing from the principle.

What is claimed is:

1. A power tool, comprising:
a housing;
a drive motor disposed in the housing;
an energy source interface for access to an energy source so as to provide a power supply for the drive motor;
a first switch disposed on a power supply circuit of the power supply and capable of controlling the drive motor to rotate in a full power output mode;
a second switch disposed on a power supply circuit of the power supply and capable of controlling the drive motor to rotate in a variable power output mode; and
a control unit electrically connected to at least the first switch and/or the second switch;
wherein the control unit is configured to:
detect a state of the first switch and a state of the second switch;
control the drive motor to rotate in the full power output mode in response to the first switch being turned on; and
control the drive motor to rotate in the variable power output mode in response to the second switch being turned on.

2. The power tool according to claim 1, wherein a maximum output power of the drive motor operating in the variable power output mode is less than an output power of the drive motor operating in the full power output mode.

3. The power tool according to claim 1, wherein the full power output mode corresponds to a maximum rotational speed of the drive motor and the variable power output mode corresponds to a plurality of speed regulation gears of the drive motor.

4. The power tool according to claim 1, wherein the control unit is configured to:
control the drive motor to stop rotating in response to the first switch being turned off; and
control the drive motor to stop rotating in response to the second switch being turned off.

5. The power tool according to claim 1, wherein the control unit is configured to:
control the drive motor to rotate in the full power output mode in a case where both the first switch and the second switch are turned on.

6. The power tool according to claim 1, further comprising:
a storage unit for storing operation data output by the control unit;
wherein the control unit is configured to:
in a process where the drive motor operates in the variable power output mode, in response to the first switch being turned on, acquire a first rotational speed of the drive motor when the first switch is turned on, store the first rotational speed in the storage unit, and control the drive motor to enter the full power output mode.

7. The power tool according to claim 6, wherein the control unit is configured to:
control the drive motor to resume rotating at the first rotational speed when the first switch is turned off.

8. The power tool according to claim 1, wherein the control unit is configured to:
in a process where the drive motor operates in the full power output mode, in response to the second switch being turned on, keep the drive motor rotating in the full power output mode.

9. The power tool according to claim 8, wherein the control unit is configured to:
in the process where the drive motor operates in the full power output mode, in response to the second switch being turned on, detect a corresponding current speed regulation gear when the second switch is turned on; and
in response to the first switch being turned off, control the drive motor to switch to a rotational speed corresponding to the current speed regulation gear.

10. The power tool according to claim 1, wherein the control unit detects an on state of the first switch and/or an on state of the second switch in real time or periodically.

11. The power tool according to claim 1, wherein the first switch and the second switch are connected in parallel between the energy source and the control unit.

12. The power tool according to claim 1, wherein any one of the second switch and the first switch is capable of individually controlling the drive motor to start and stop.

13. The power tool according to claim 1, wherein the first switch is a signal switch.

14. The power tool according to claim 1, wherein, in a process where the drive motor rotates in the variable power output mode, a rotational speed of the drive motor is capable of being gradually increased from low to high.

15. A power tool, comprising:
a housing;
a drive motor disposed in the housing;
an energy source interface for access to an energy source so as to provide a power supply for the drive motor;
a first switch disposed on a power supply circuit of the power supply;
a second switch disposed on a power supply circuit of the power supply; and
a control unit electrically connected to the first switch and/or the second switch;
wherein the control unit is configured to:
detect a state of the first switch and a state of the second switch;
control the drive motor to rotate in a first operation mode in response to the first switch being turned on; and
control the drive motor to rotate in a second operation mode in response to the second switch being turned on.

16. The power tool according to claim 15, wherein an output power of the drive motor operating in the first operation mode is different from an output power of the drive motor operating in the second operation mode.

17. A blower, comprising:
a housing;
a drive motor;
a power interface for access to a power supply so as to provide the power supply for the drive motor;
a first switch disposed on a power supply circuit of the power supply and capable of controlling the drive motor to rotate in a maximum rotational speed output mode; and
a second switch disposed on a power supply circuit of the power supply and capable of controlling the drive motor to rotate in a variable rotational speed output mode;
a control unit configured to:
detect a state of the first switch and a state of the second switch;
control the drive motor to rotate in the maximum rotational speed output mode in response to the first switch being turned on; and
control the drive motor to rotate in the variable rotational speed output mode in response to the second switch being turned on.

18. The blower according to claim 17, wherein the control unit is configured to:
control the drive motor to stop rotating in response to the first switch being turned off; and
control the drive motor to stop rotating in response to the second switch being turned off.

19. The blower according to claim 17, wherein the control unit is configured to:
control the drive motor to rotate in the maximum rotational speed output mode in a case where both the first switch and the second switch are turned on.

20. The blower according to claim 17, further comprising:
a storage unit for storing operation data output by the control unit;
wherein the control unit is configured to:
in a process where the drive motor operates in the variable rotational speed output mode, in response to the first switch being turned on, acquire a first rotational speed of the drive motor when the first switch is turned on, store the first rotational speed in the storage unit, and control the drive motor to enter the maximum rotational speed output mode.
